(19) United States
(12) Patent Application Publication
(10) Pub. No.: US 2015/0268610 A1
(43) Pub. Date: Sep. 24, 2015

(54) IMAGE FORMING APPARATUS, LOG STORING APPARATUS, AND NON-TRANSITORY COMPUTER READABLE MEDIUM

(71) Applicant: FUJI XEROX CO., LTD., Tokyo (JP)

(72) Inventors: Daichi TAKAHASHI, Kanagawa (JP); Noriyuki SUZUMURA, Kanagawa (JP); Kazutoshi KONDO, Kanagawa (JP); Yutaka IKEDA, Kanagawa (JP); Kazuya TAKAHASHI, Kanagawa (JP); Tomoya IMAI, Kanagawa (JP); Kazumi YANAGIDAIRA, Kanagawa (JP); Takashi TOMIZUKA, Kanagawa (JP); Hideki SOEJIMA, Kanagawa (JP); Makoto MACHIDA, Kanagawa (JP)

(73) Assignee: FUJI XEROX CO., LTD, Tokyo (JP)

(21) Appl. No.: 14/479,981

(22) Filed: Sep. 8, 2014

(30) Foreign Application Priority Data
Mar. 20, 2014 (JP) 2014-059015

(51) Int. Cl. G03G 15/00

(52) U.S. Cl. CPC G03G 15/5012

(57) ABSTRACT

An image forming apparatus includes a log storing unit that stores a log of each of plural object items that are set in advance, and a setting unit that, when an error occurs, selects predetermined one or more object items from the plural object items on the basis of a type of the error, and makes a setting such that logs of the selected one or more object items are stored in the log storing unit.

### CROSS-REFERENCE TO RELATED APPLICATIONS

This application is based on and claims priority under 35 USC 119 from Japanese Patent Application No. 2014-059015 filed Mar. 20, 2014.

### BACKGROUND

The present invention relates to an image forming apparatus, a log storing apparatus, and a non-transitory computer readable medium.

### SUMMARY

According to an aspect of the invention, there is provided an image forming apparatus including: a log storing unit that stores a log of each of plural object items that are set in advance; and a setting unit that, when an error occurs, selects predetermined one or more object items from the plural object items on the basis of a type of the error, and makes a setting such that logs of the selected one or more object items are stored in the log storing unit.

### BRIEF DESCRIPTION OF THE DRAWINGS

An Exemplary embodiment of the present invention will be described in detail based on the following figures, wherein:

FIG. 1 is a configuration diagram illustrating an image forming apparatus according to an exemplary embodiment;

FIG. 2 is a block diagram illustrating the hardware configuration of a controller of the image forming apparatus;

FIG. 3 is a functional block diagram illustrating functions realized by a log storage unit;

FIG. 4 illustrates a determination table stored in a storage object log defining unit;

FIG. 5 is a flowchart illustrating the flow of a process performed for a log storing process;

FIG. 6 is a flowchart illustrating the flow of a process performed for a log storing process;

FIG. 7 illustrates another exemplary configuration of the log storage unit;

FIG. 8 illustrates an error count table generated by a user/error statistics unit;

FIG. 9 is a flowchart illustrating the flow of a process performed by the log storage unit; and

FIG. 10 is a flowchart illustrating the flow of a process performed by the log storage unit.

### DETAILED DESCRIPTION

An exemplary embodiment of the present invention will now be described in detail with reference to the accompanying drawings.

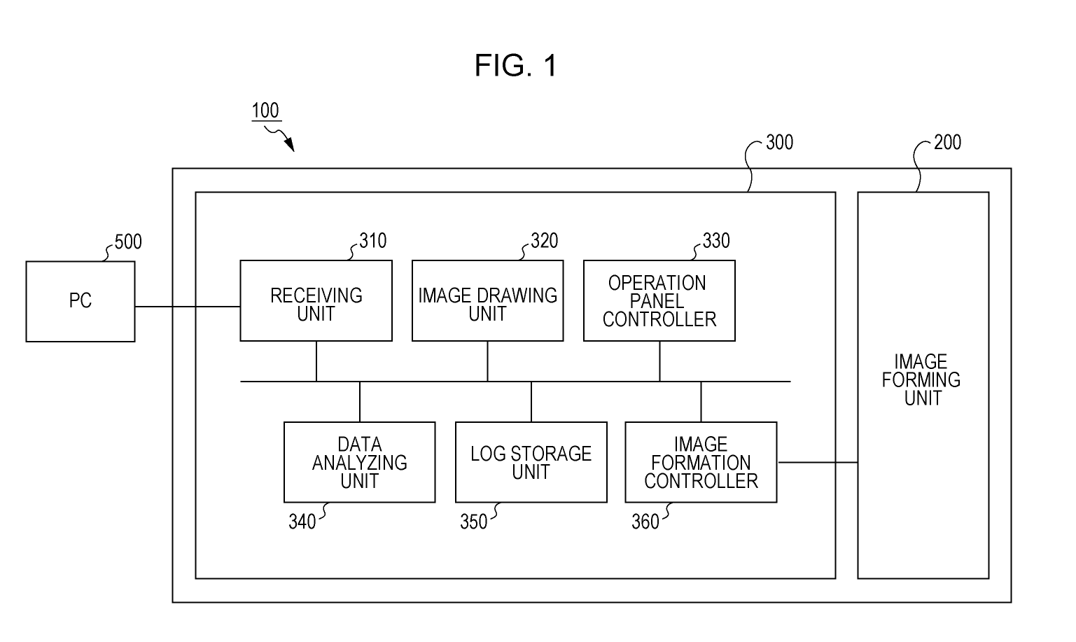

FIG. 1 is a configuration diagram illustrating an image forming apparatus 100 according to this exemplary embodiment.

The image forming apparatus 100 includes an image forming unit 200 that forms an image on a recording material such as paper. The image forming apparatus 100 also includes a controller 300 that controls each unit of the image forming apparatus 100.

The image forming unit 200 forms an image on a recording material, using an electrophotographic system, for example. According to the electrophotographic system, the peripheral surface of a photoconductor drum is charged to a predetermined potential. Then, an electrostatic latent image is formed on the peripheral surface by radiating an optical beam to the peripheral surface. After that, toner is applied to the electrostatic latent image so as to form a toner image. Then, the toner image is transferred to the recording material. Thus, an image is formed on the recording material. Note that the electrophotographic system is merely an example, and other systems such as an inkjet system may be used for forming an image.

The controller 300 includes a receiving unit 310, an image drawing unit 320, an operation panel controller 330, a data analyzing unit 340, a log storage unit 350, and an image formation controller 360.

The receiving unit 310 receives information transmitted from a personal computer (PC) 500 or the like that is provided externally. For example, the receiving unit 310 receives image data, image formation conditions, user information on a user who performs image formation.

The image drawing unit 320 performs rendering (drawing development) of the image data received by the receiving unit 310, and thereby generates print image data (bit map data) that is represented by pixels arranged in a matrix form.

The image formation controller 360 controls the image forming unit 200. More specifically, the image formation controller 360 controls the image forming unit 200 in accordance with the image formation conditions and the like received by the receiving unit 310. Thus, an image is formed on a recording material in accordance with the image formation conditions specified by the user or the like.

The operation panel controller 330 performs display control of information on an operation panel (not illustrated). Further, in the case where the operation panel includes a touch panel display, the operation panel controller 330 receives information from the user, which is input by the user by operating the display.

The data analyzing unit 340 analyzes information generated in the image forming apparatus 100 and information transmitted from the outside of the image forming apparatus 100.

The log storage unit 350 stores a log (history information) of each of various types of processing performed by the image forming apparatus 100. If an error occurs in the image forming apparatus 100, the cause of the error may be quickly identified by referring to the log stored in the log storage unit 350.

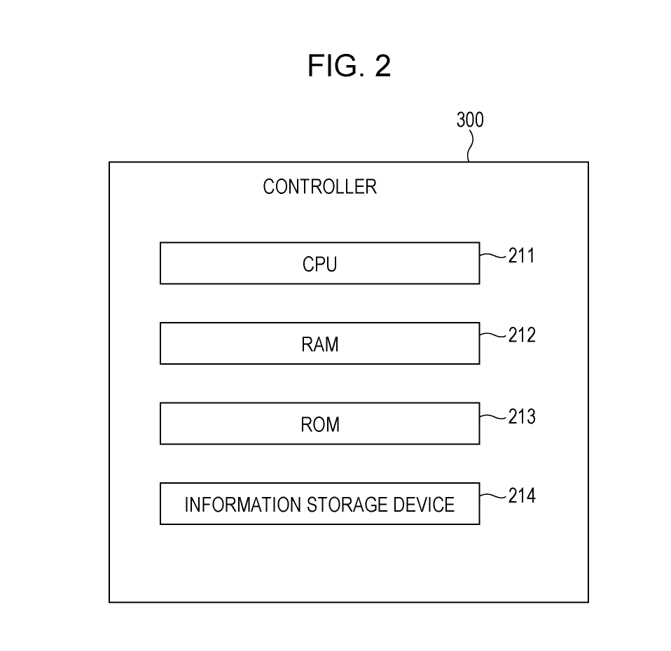

FIG. 2 is a block diagram illustrating the hardware configuration of the controller 300 of the image forming apparatus 100.

The controller 300 includes a central processing unit (CPU) 211 that performs arithmetic operations in accordance with a predetermined program, a random access memory (RAM) 212 that serves as a work memory or the like of the CPU 211, a read only memory (ROM) 213 that stores various setting values and the like that are used for the processing in the CPU 211, and an information storage device 214 including a hard disk drive.

In the controller 300, the CPU 211 reads a program stored in the ROM 213, and executes the program while using the RAM 212 as a work area. Thus, the functional units illustrated in FIG. 1 are realized.

As for the form of providing the above program, the program may be stored in advance in the ROM 213 and then loaded into the RAM 212. Further, in the case where the ROM 213 is a rewritable ROM such as an EEPROM, after completion of the settings of the CPU 211, the program may be installed alone in the ROM 213, and then loaded into the RAM 212. Further, the program may be transmitted via a network such as the Internet, installed in the ROM 213, and then loaded into the RAM 212. Further, the program may be loaded from an external storage medium such as a DVD-ROM and a flash memory into the RAM 212.

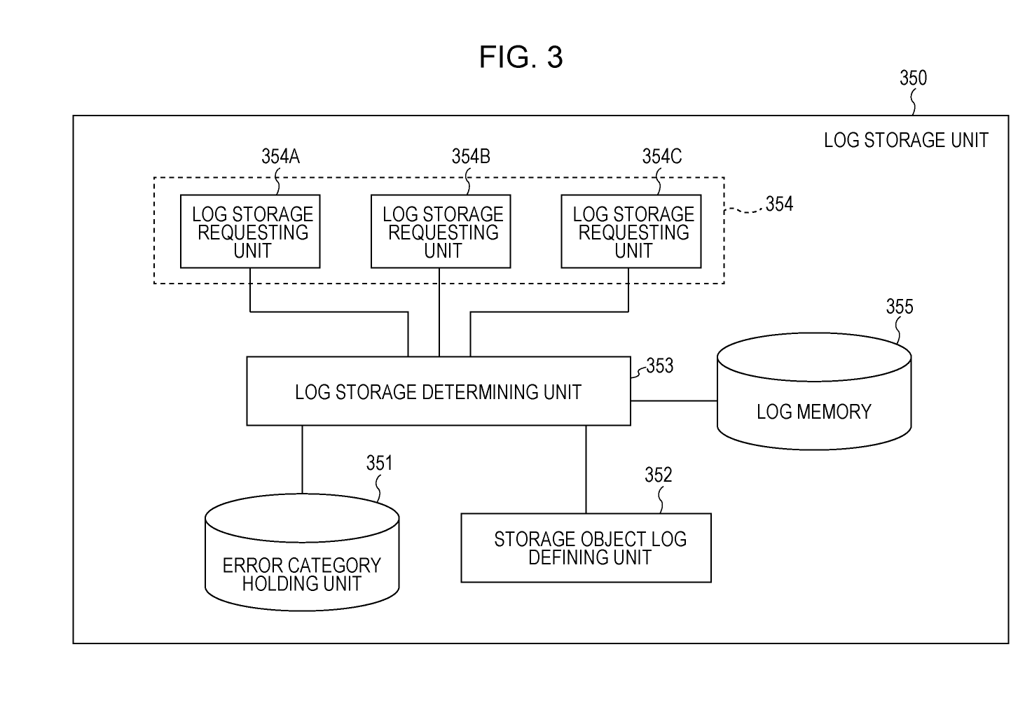

FIG. 3 is a functional block diagram illustrating functions realized by the log storage unit 350.

The log storage unit 350 includes an error category holding unit 351, a storage object log defining unit 352, a log storage determining unit 353, a log storage requesting unit 354, and a log memory 355.

When an error occurs in the image forming apparatus 100, the error category holding unit 351 holds information on an error category to which the occurred error belongs. That is, the error category holding unit 351 holds information on the type of the occurred error.

The storage object log defining unit 352 stores a determination table used for determining whether to store a log of each of plural predetermined log storage object items.

When a request for storing a log is received, the log storage determining unit 353 determines whether to store the log, by referring to the determination table stored in the storage object log defining unit 352.

The log storage requesting unit 354 requests the log storage determining unit 353 to store a log when processing corresponding to a log storage object item is performed. Note that there are provided plural log storage requesting units 354 (see log storage requesting units 354A through 354C) in the image forming apparatus 100. The plural log storage requesting units 354 correspond to the plural log storage object items that are set. In this exemplary embodiment, when processing corresponding to a log storage object item is performed, the log storage requesting unit (one of the log storage requesting units 354A through 354C) corresponding to the log storage object item transmits to the log storage determining unit 353 a request for storing a log, the log storage object item, and the concrete content of the log.

The log memory 355 is an example of a log storing unit, and stores a log. More specifically, the log memory 355 stores a log of a log storage object item that is permitted by the log storage determining unit 353 to be stored. In this exemplary embodiment, logs are sequentially stored in the log memory 355. Thus, when the log memory 355 runs out of space, a new log is stored by overwriting the existing log.

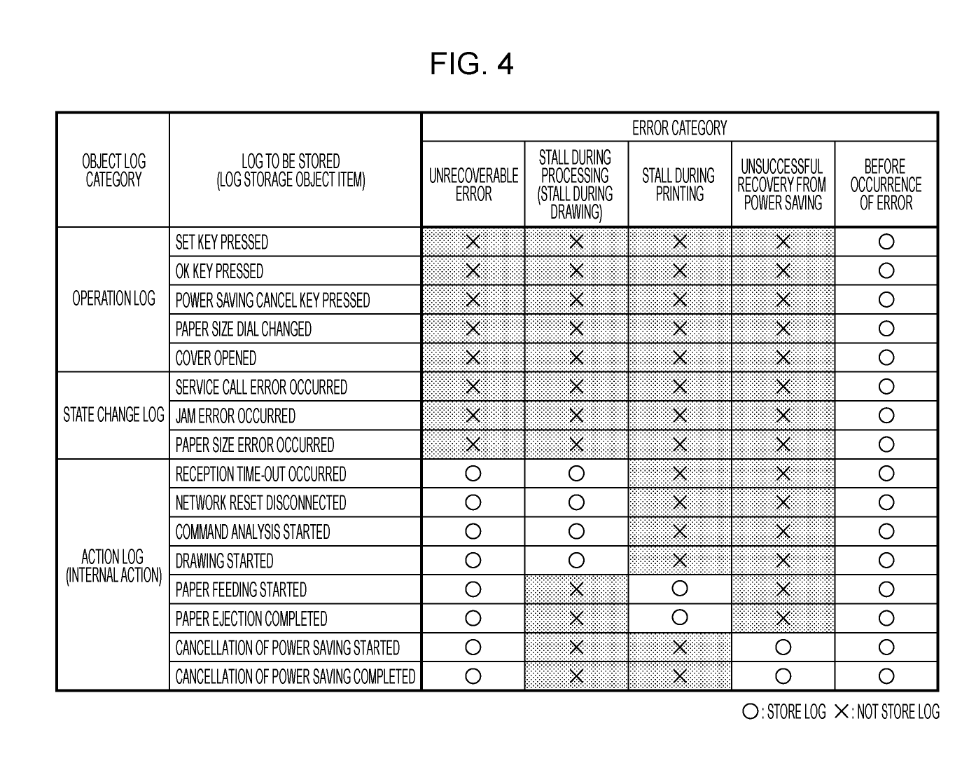

FIG. 4 illustrates the determination table stored in the storage object log defining unit 352.

In this exemplary embodiment, errors that occur in the image forming apparatus 100 are classified into four error categories (types). More specifically, as shown in the top row of the determination table, errors are classified into four error categories: “unrecoverable error”, “stall during processing (stall during drawing)”, “stall during printing”, and “unsuccessful recovery from power saving”. Note that the term “stall” indicates that processing stops in the middle.

The left column (the second column from the left) in the determination table shows log storage object items for which log storage is performed, such as “SET key pressed” and “OK key pressed”. In the example of FIG. 4, a total of 16 log storage object items are provided.

Further, in this exemplary embodiment, the log storage object items are classified into three log categories (“operation log”, “state change log”, and “action (internal action) log”). Each of the log storage object items belongs to one of the “operation log”, “state change log”, and “action log”.

An operation log is a log for storing a user operation. A state change log is a log for storing an occurrence of an error. An action log is a log for storing an internal action performed in the controller 300.

Further, in the determination table, an instruction whether to store a log of each log storage object item is provided for each of the four error categories. In FIG. 4, “◯” indicates an instruction to store a log, and “x” indicates an instruction not to store a log.

Although not described above, it is known from past experiences that errors that may occur in a certain environment generally tend to belong to the same error category. More specifically, in the image forming apparatus 100, it is often the case that errors in the same error category occur rather than errors in different error categories.

Accordingly, in this exemplary embodiment, if an error belonging to one of the four error categories occurs, logs related to this error category are collected from then on. That is, logs required for analyzing errors in this error category are collected from then on.

Further, in this exemplary embodiment, if an error belonging to one of the four error categories occurs, one or more log storage object items related to this error category are selected from a total of 16 log storage object items. Then, in this exemplary embodiment, logs of the selected one or more log storage object items are stored in the log memory 355. Thus, the information amount of logs stored in the log memory 355 is reduced.

Note that, after use of the image forming apparatus 100 is started until the first error belonging to one of the error categories occurs, it is not known which error category the first error belongs to. Therefore, in this exemplary embodiment, until the first error belonging to one of the error categories occurs, logs of all the log storage object items are stored (see the rightmost column “before occurrence of error” in FIG. 4).

The following describes specific examples.

For instance, if an “unrecoverable error” occurs first among the four error categories, as illustrated in FIG. 4, logs of the log storage object items belonging to the “operation log” and the “state change log” are not stored from then on, and logs of the log storage object items belonging to the “action log” are stored.

Further, for instance, if a “stall during processing (stall during drawing)” occurs first, logs of the log storage object items belonging to the “operation log” and the “state change log” are not stored from then on. In this case, the error is a stall of an internal action during drawing. Therefore, among the log storage object items belonging to the “action log”, logs of the log storage object items related to paper feeding and the like and logs of the log storage object items related to power saving are not stored.

Further, for instance, if a “stall during printing” occurs first, logs of the log storage object items belonging to the “operation log” and the “state change log” are not stored from then on. In this case, the error is a stall of an internal action during printing. Therefore, among the log storage object items belonging to the “action log”, logs of the log storage object items related to processing prior to paper feeding and logs of the log storage object items related to power saving are not stored.

Further, for instance, if an “unsuccessful recovery from power saving” occurs first, logs of the log storage object items belonging to the “operation log” and the “state change log” are not stored from then on. As for the “action log”, only logs of the log storage object items related to power saving are stored.

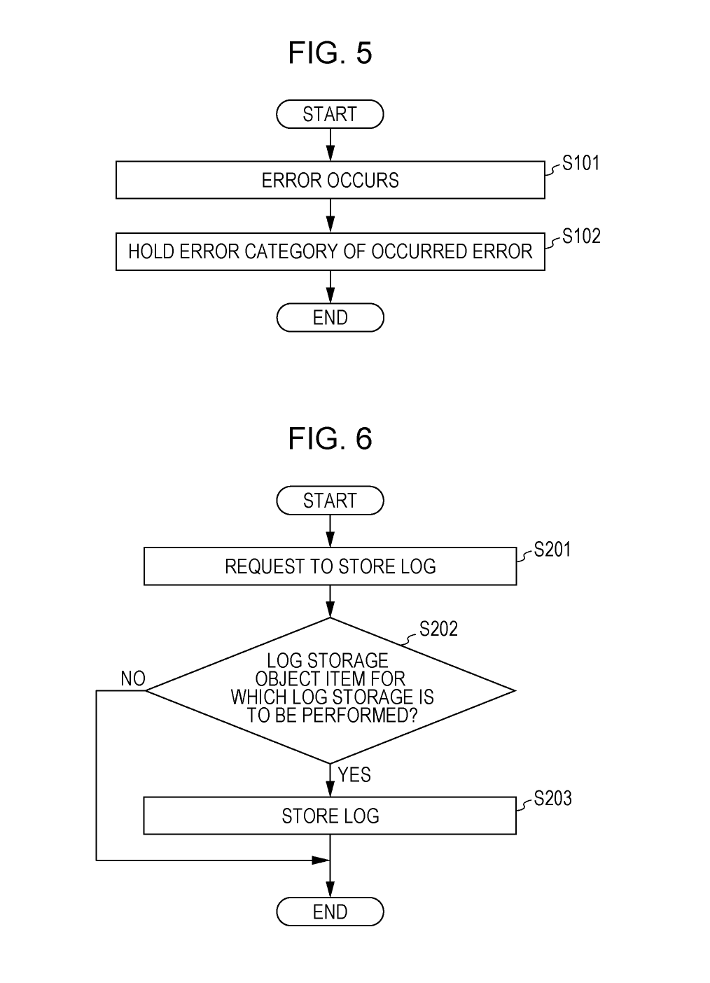

FIGS. 5 and 6 are flowcharts each illustrating the flow of a process performed for a log storing process.

As illustrated in FIG. 5, in the image forming apparatus 100 of this exemplary embodiment, when an error occurs (step S101), the error category holding unit 351 (see FIG. 3) determines which of the four error categories the error belongs to, and thus identifies the error category to which the error belongs. Then, the error category holding unit 351 holds the identified error category (step S102).

FIG. 6 is a flowchart illustrating the flow of a process performed when processing corresponding to a log storage object item is performed.

In this exemplary embodiment, when processing corresponding to any of log storage object items is performed, the log storage requesting unit 354 (one of the log storage requesting units 354A through 354C) transmits to the log storage determining unit 353 a request for storing a log of the log storage object item (step S201).

Then, the log storage determining unit 353 determines whether the log storage object item of the log requested to be stored is a log storage object item for which log storage is to be performed, on the basis of the error category held in the error category holding unit 351 and the determination table of FIG. 4 (step S202). Then, if the log storage determining unit 353 determines that the log storage object item is a log storage object item for which log storage is to be performed, the log requested to be stored is stored in the log memory 355 (step S203). On the other hand, if the log storage determining unit 353 determines that the log storage object item is not a log storage object item for which log storage is to be performed, the process ends without storing the log.

The following describes the processing of step S202 in greater detail. In this exemplary embodiment, the log storage determining unit 353 serving as a setting unit first selects one or more log storage object items from a total of 16 log storage object items, on the basis of the error category held in the error category holding unit 351 and the determination table of FIG. 4. More specifically, the log storage determining unit 353 selects one or more log storage object items related to the error category held in the error category holding unit 351, from a total of 16 log storage object items.

Then, in this exemplary embodiment, if the log storage object item of the log requested to be stored is included in the selected one or more log storage object items, the log is output from the log storage determining unit 353 to the log memory 355, and is stored in the log memory 355.

The processing of step S202 will be described with reference to specific examples.

For instance, if the error category held by the error category holding unit 351 is the “stall during printing” and if the log storage object item of the log requested to be stored is the “jam error occurred” belonging to the “state change log”, since “x” indicating an instruction not to store a log is shown in FIG. 4, the log of the “jam error occurred” is not stored. On the other hand, if the log storage object item is the “paper feeding started” belonging to the “action log”, since “◯” is shown in FIG. 4, the log of the “paper feeding started” is stored.

Further, for instance, if the error category held by the error category holding unit 351 is the “unsuccessful recovery from power saving” and if the log storage object item is the “OK key pressed” belonging to the “operation log”, since “x” is shown in FIG. 4, the log of the “OK key pressed” is not stored. On the other hand, if the log storage object item is the “cancellation of power saving started” belonging to the “action log”, since “◯” is shown in FIG. 4, the log of the “cancellation of power saving started” is stored.

As described above, the error category holding unit 351 holds the error category to which the first occurred error belongs, and then a determination of whether to store a log is made on the basis of the error category held by the error category holding unit 351.

However, this is not a limiting example. In the case where an error belonging to an error category different from the error category of the first occurred error occurs later on, the error category held by the error category holding unit 351 (the first held error category) may be replaced with this different error category. That is, each time an error belonging to a different error category occurs, the error category held by the error category holding unit 351 may be replaced with the error category to which the newly occurred error belongs.

Further, for example, the number of occurrences of errors of each category may be counted for each error category such that the error category with the highest error occurrence frequency may be held by the error category holding unit 351.

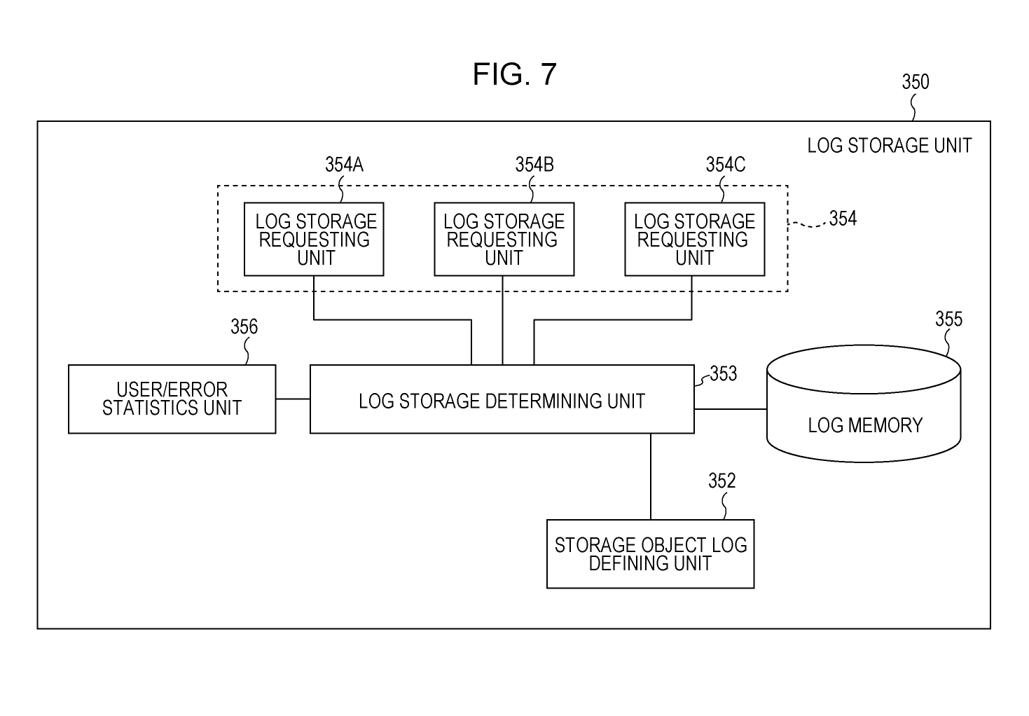

FIG. 7 illustrates another exemplary configuration of the log storage unit 350.

Components having the same functions as those of FIG. 3 are denoted by the same reference numerals as in FIG. 3, and a description thereof will be omitted.

A log storage unit 350 of FIG. 7 includes a user/error statistics unit 356. The user/error statistics unit 356 counts the number of errors occurred for each user and each of the four error categories. Further, the user/error statistics unit 356 writes the counted number of occurrences of errors to the error count table, and generates an error count table storing the number of occurrences of errors.

Further, similar to that of FIG. 3, the log storage unit 350 of FIG. 7 includes a storage object log defining unit 352. The storage object log defining unit 352 stores the same determination table as that shown in FIG. 4.

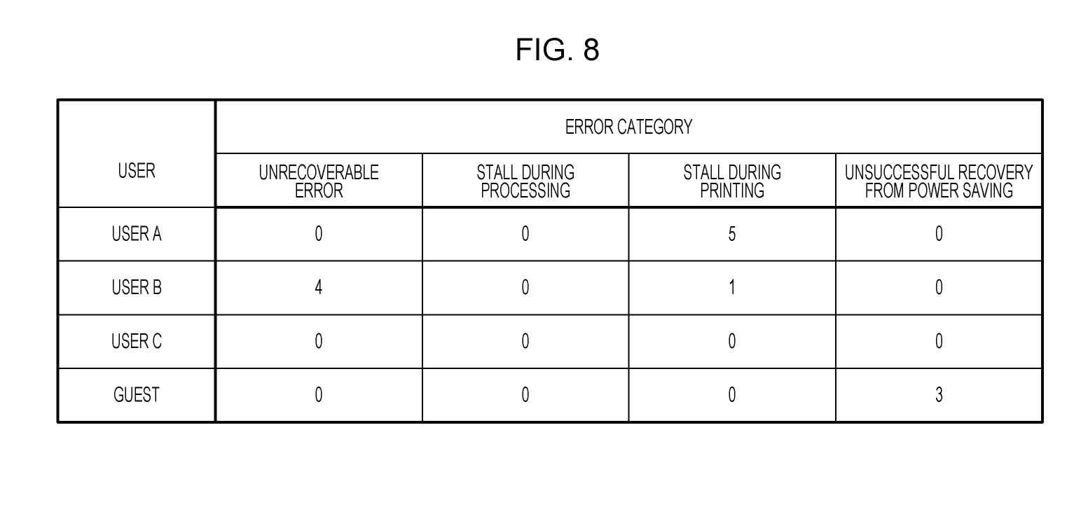

FIG. 8 illustrates an error count table generated by the user/error statistics unit 356.

When an error occurs in the image forming apparatus 100, the user/error statistics unit 356 identifies the user who has been using the image forming apparatus 100 at the time of the occurrence of the error. Further, the user/error statistics unit 356 identifies which of the four error categories the error belongs to. Then, the user/error statistics unit 356 adds 1 to (increments) the value in the cell corresponding to the identified user and the identified error category in the error count table.

Note that the user may be identified on the basis of, for example, the user information transmitted from the PC 500 (see FIG. 1). Alternatively, for example, a card reader may be provided in the image forming apparatus 100 such that the user may be identified by reading the user ID from the ID card of the user.

In the example of FIG. 8, the image forming apparatus 100 is used by users A through C. Further, in this example, an error belonging to the “stall during printing” occurred five times during use by the user A. Further, an error belonging to the “unrecoverable error” occurred four times, and an error belonging to the “stall during printing” occurred one time during use by the user B. Further, in the example of FIG. 8, no error occurred during use by the user C.

In the case where a new user uses the image forming apparatus 100, a registration process is performed for the user, so that the number of occurrences of errors is counted for the user.

Further, in the case where the user using the image forming apparatus 100 is unknown, the user is treated as a guest as shown in FIG. 8.

Since the operation method used by the user, the use conditions, and the like often differ between users, the error category in which errors frequently occur differs between users, as shown in FIG. 8. In this exemplary embodiment, the error category in which errors frequently occur is identified for each user, and a determination of whether to store a log is made on the basis of the identified error category.

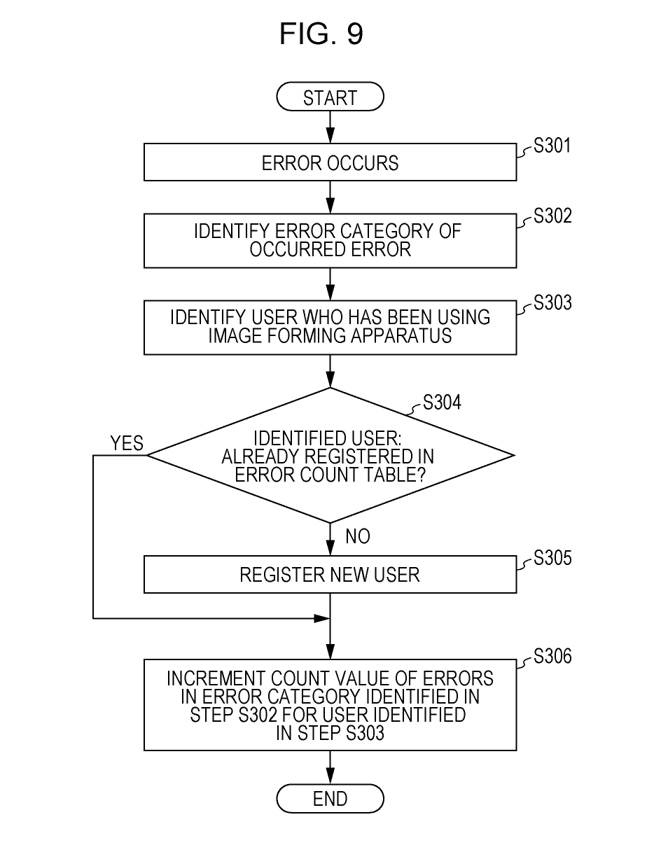

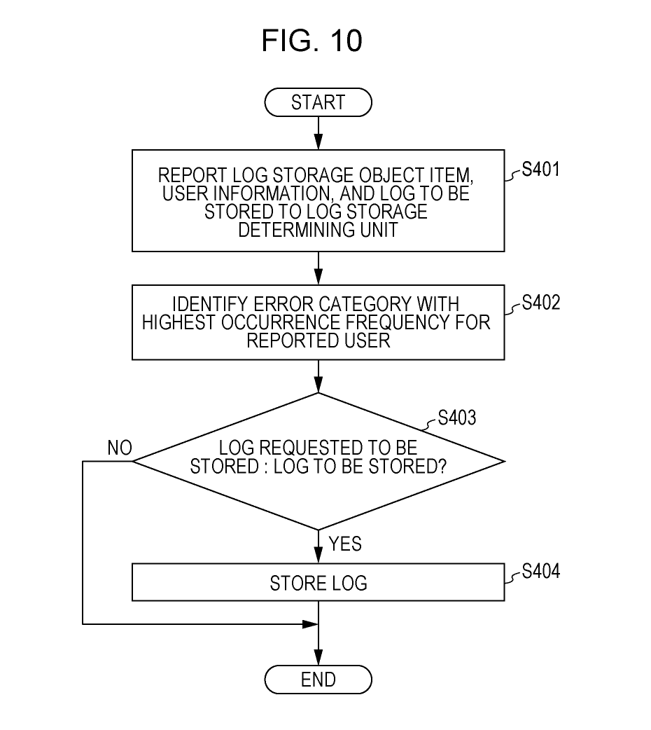

FIGS. 9 and 10 are flowcharts each illustrating the flow of a process performed by the log storage unit 350 of FIG. 7.

As shown in FIG. 9, when an error occurs (step S301), the user/error statistics unit 356 first identifies the error category to which the error belongs (step S302). Then, the user/error statistics unit 356 identifies the user who has been using the image forming apparatus 100 at the time of the occurrence of the error (step S303). Then, the user/error statistics unit 356 determines whether the identified user is already registered in the error count table (step S304).

Then, if the user/error statistics unit 356 determines that the user is registered, the process skips step S305 and proceeds to step S306.

On the other hand, if the user/error statistics unit 356 determines that the user is not registered, the user/error statistics unit 356 performs registration of the user (registration of a new user) in the error count table (step S305). When this registration is made, the count value in each error category for this user is set to 0.

Then in step S306, the user/error statistics unit 356 increments (adds 1 to) the count value of errors in the error category identified in step S302 for the user who has been using the image forming apparatus 100 upon occurrence of the error (the user identified in step S303).

FIG. 10 is a flowchart illustrating the flow of a process performed when processing corresponding to a log storage object item is performed.

When processing corresponding to any of the log storage object items is performed, the log storage requesting unit 354 (one of the log storage requesting units 354A through 354C) reports information on the user who has been using the image forming apparatus 100 at the time of the execution of the processing, the log storage object item, and the concrete content of a log to the log storage determining unit 353 (step S401).

Then, the log storage determining unit 353 identifies the error category with the highest error occurrence frequency for the user reported in step S401, by referring to the error count table described above (step S402). More specifically, the log storage determining unit 353 serving also as an identifying unit identifies the error occurrence status of the user reported in step S401, by referring to the error count table.

Then, the log storage determining unit 353 determines whether the log requested to be stored is a log to be stored, on the basis of the error category identified in step S402 and the determination table (the determination table of FIG. 4) stored in the storage object log defining unit 352 (step S403).

Then, if the log storage determining unit 353 determines that the log is a log to be stored, the log is stored in the log memory 355 (step S404). On the other hand, if the log storage determining unit 353 determines that the log is not a log to be stored, the log is not stored in the log memory 355.

More specifically, in this exemplary embodiment, when an image formation is performed by the user, the log storage determining unit 353 serving as a setting unit identifies the previous error occurrence status of this user. Then, the log storage determining unit 353 selects one or more log storage object items from the 16 log storage object items, on the basis of the error occurrence status. Then, if the log storage object item of the log requested to be stored is included in the selected one or more log storage object items, the log storage determining unit 353 outputs the log to the log memory 355. Then, the output log is stored in the log memory 355.

Now, the processing of FIG. 10 will be described with reference to specific examples.

For instance, if the user reported in step S401 is the user A, the error category with the highest error occurrence frequency is the “stall during printing” as shown in FIG. 8. Then, in this exemplary embodiment, the determination table of FIG. 4 is referred to, and a determination of whether to store log is made on the basis of the error category with the highest occurrence frequency, which is the “stall during printing”, and the log storage object item of the log requested to be stored.

For example, if the log storage object item of the log requested to be stored is the “paper size error occurred” belonging to the “state change log”, since “x” is shown in FIG. 4, the log is not stored. On the other hand, if the log storage object item is the “paper ejection completed” belonging to the “action log”, since “◯” is shown in FIG. 4, the log of the “paper ejection completed” is stored.

In this way, even in the processing example of FIGS. 9 and 10, logs of the selected one or more log storage object items are stored instead of storing logs of all the log storage object items. That is, when the user uses the image forming apparatus 100, logs of one or more log storage object items selected for the user are stored instead of storing logs of all the log storage object items. Accordingly, as in the case described above, the size of the memory required for storing logs may be reduced. That is, the information amount of logs stored in the log memory 355 is reduced.

### Miscellaneous

The memory usage may be reduced by other methods than the processing illustrated in FIGS. 9 and 10. For example, the memory usage may be reduced by setting in advance a log storage object item for which log storage is performed for each user. In this case, however, each time the environmental conditions change, such as addition or deletion of a user, the settings need to be changed, which requires troublesome work. Especially, in the case where there are a large number of users, it is very cumbersome to make settings. On the other hand, the configuration of this exemplary embodiment eliminates the need to make such settings in advance, and enables storage of required logs.

In the example described above, the log storage unit 350 is provided in the image forming apparatus 100. However, the log storage unit 350 may be provided outside the image forming apparatus 100, such as in an external server apparatus. In this case, the server apparatus or the like in which the log storage unit 350 is provided may be regarded as a log storing apparatus.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a log storing unit that stores a log of each of a plurality of object items that are set in advance; and
a setting unit that, when an error occurs, selects predetermined one or more object items from the plurality of object items on a basis of a type of the error, and makes a setting such that logs of the selected one or more object items are stored in the log storing unit.

2. The image forming apparatus according to claim 1, wherein, during a period before a first error occurs, logs of all the plurality of object items are set to be stored in the log storing unit.

3. An image forming apparatus comprising:
a log storing unit that stores a log of each of a plurality of object items that are set in advance;
an identifying unit that identifies an error occurrence status for each user of users, the error occurrence status being an occurrence status of errors occurred upon image formation by the user; and
a setting unit that, when image formation is performed by the user, selects one or more object items from the plurality of object items on the basis of the error occurrence status of the user, and makes a setting such that logs of the selected one or more object items are stored in the log storing unit.

4. The image forming apparatus according to claim 3, wherein:
the identifying unit identifies a number of occurrences of errors of each of types of errors for the user; and
the setting unit makes the setting such that, when image formation is performed by the user, a log of an object item related to a most frequently occurred error among errors occurred upon image formation by the user is stored in the log storage unit.

5. A log storing apparatus comprising:
a log storing unit that stores a log of each of a plurality of object items that are set in advance, the log being related to each type of processing performed in an image forming apparatus; and
a setting unit that selects predetermined one or more object items from the plurality of object items on a basis of a type of an error occurred in the image forming apparatus, and makes a setting such that logs of the selected one or more object items are stored in the log storing unit.

6. A log storing apparatus comprising:
a log storing unit that stores a log of each of a plurality of object items that are set in advance, the log being related to each type of processing performed in an image forming apparatus;
an identifying unit that identifies an error occurrence status for each user of users, the error occurrence status being an occurrence status of errors occurred upon image formation by the user; and
a setting unit that, when image formation is performed by the user, selects one or more object items from the plurality of object items on a basis of the error occurrence status of the user, and makes a setting such that logs of the selected one or more object items are stored in the log storing unit.

7. A non-transitory computer readable medium storing a program causing a computer to execute a process comprising:
selecting one or more object items for which log storage is performed, from a plurality of object items, on a basis of a type of an error occurred in an image forming apparatus; and
making a setting such that logs of the one or more object items selected by the selecting are stored in a log storing unit.

8. A non-transitory computer readable medium storing a program causing a computer to execute a process comprising:
selecting one or more object item for which log storage is performed, from a plurality of object items, on a basis of an occurrence status of errors occurred in an image forming apparatus upon image formation by a user using the image forming apparatus; and
making a setting such that logs of the one or more object items selected by the selecting are stored in a log storing unit.
